(19) United States
(12) Patent Application Publication
(10) Pub. No.: US 2011/0308218 A1
(43) Pub. Date: Dec. 22, 2011

(54) STABILIZER DEVICE FOR A LAWN TRIMMER

(76) Inventors: LANCE MICHAEL DUNN, Monroe, NC (US); Bob Johnson, Monroe, NC (US)

(21) Appl. No.: 13/156,707

(22) Filed: Jun. 9, 2011

Related U.S. Application Data
(60) Provisional application No. 61/355,974, filed on Jun. 17, 2010.

(51) Int. Cl. A01D 34/00

(52) U.S. Cl. 56/16.7

(57) ABSTRACT

A stabilizer device for a lawn trimmer prevents back strain on the user while trimming. In addition, the present invention provides a stabilizer device for a lawn trimmer that prevents uneven cut heights during the operation of the lawn trimmer device while the user may stand straight. The stabilizer device for a lawn trimmer includes a bracket system adapted to be attached to a shaft of the lawn trimmer and a base connected to the bracket system. The base includes a vertical frame having a first leg and a second leg. Each one of the legs includes a plurality of retaining fingers connected to a bottom end. The plurality of retainer fingers work together to receive and retain a ball.

### CROSS-REFERENCE TO RELATED APPLICATIONS

This application claims the benefit of priority to U.S. Provisional Application No. 61/355,974 filed Jun. 17, 2010, the contents of which are incorporated herein by reference.

### BACKGROUND OF THE INVENTION

The present invention generally relates to grass trimmers. More particularly, the present invention relates to a stabilizer device for lawn trimmers.

Lawn trimmers are widely used to trim vegetation in areas not easily accessible to lawn mowers. However, lawn trimmers must be physically supported by the user above the ground to trim the vegetation at the desired height. Unfortunately, holding the device out from their body and maneuvering the lawn trimmer throughout the work area leads to back strain and physical stresses to the user.

As can be seen, there is a need for a device that enables a lawn trimmer to be supported a vertical distance above the ground.

### SUMMARY OF THE INVENTION

In one aspect of the present invention, a stabilizer device for a lawn trimmer includes a bracket system adapted to be attached to a shaft of the lawn trimmer and a base connected to the bracket system, the base includes a vertical frame having a first leg and a second leg, each one of the legs includes a plurality of retaining fingers connected to a bottom end, the plurality of retainer fingers work together to receive and retain a ball.

These and other features, aspects and advantages of the present invention will become better understood with reference to the following drawings, description and claims.

### BRIEF DESCRIPTION OF THE DRAWINGS

FIG. 1 illustrates a perspective front view of a stabilizer device for a lawn trimmer according to an exemplary embodiment of the present invention showing the stabilizer device in use;

FIG. 2 illustrates a side view of the stabilizer device of FIG. 1;

FIG. 3 illustrates a cross-sectional view of the stabilizer device taken along line 3-3 of FIG. 1 showing details of a bracket system according to an exemplary embodiment of the present invention;

FIG. 4 illustrates a cross-sectional view of the stabilizer device taken along line 4-4 of FIG. 1;

FIG. 5 illustrates a front view of one of the plates of the bracket system according to an exemplary embodiment of the present invention; and

FIGS. 6-9 illustrate detailed views showing the stabilizer device connected at different angles with respect to a shaft of the lawn trimmer.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a stabilizer device for a lawn trimmer that prevents back strain on the user while trimming. In addition, the present invention provides a stabilizer device for a lawn trimmer that prevents uneven cut heights during the operation of the lawn trimmer device while the user may stand straight.

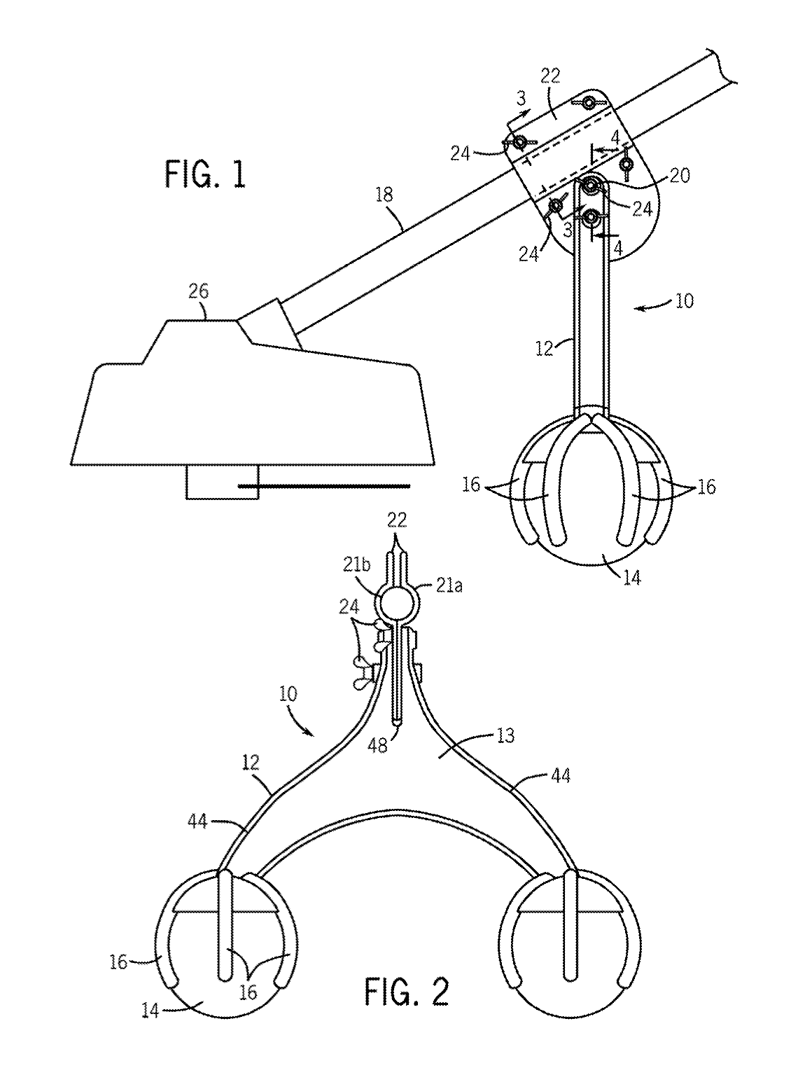

FIGS. 1-2 illustrate a stabilizer device 10 for a lawn trimmer 26 according to an exemplary embodiment of the present invention. The stabilizer device 10 may be adapted to be mounted on a shaft 18 of the lawn trimmer 26. The stabilizer device 10 may include a bracket system 22 attached to the shaft 18 of the lawn trimmer 26. Fastener devices 24 may be used to attach the stabilizer device 10 to the shaft 18.

A base 12 may be used to secure the bracket system 22. The base 12 may be pivotally connected to the bracket system 22 at a pivot point 20. Fastener devices 24 may be used to attach the base 12 to the bracket system 22.

The base 12 may be made of a sturdy material. In some embodiments, the base 12 may be made of plastic, metal, polymer, fiber reinforced plastic, or composite material. The base 12 may include a vertical frame 13, a first leg 44 and a second leg 44. The vertical frame 13 may include a slot 48 on the top end. The stabilizer device 10 for a lawn trimmer 26 according to the present invention replaces the wheels of the prior art devices by balls 14 in order to obtain a smooth ride. Using balls 14 may prevent uneven cut heights, such as those caused by tipping and scalping. In addition, the balls 14 may be self-cleaning and do not require cleaning, like the wheels do. Furthermore, balls 14 may not require constant lubrication as required by the wheels. Finally, the balls 14 are lightweight as compared with the wheels.

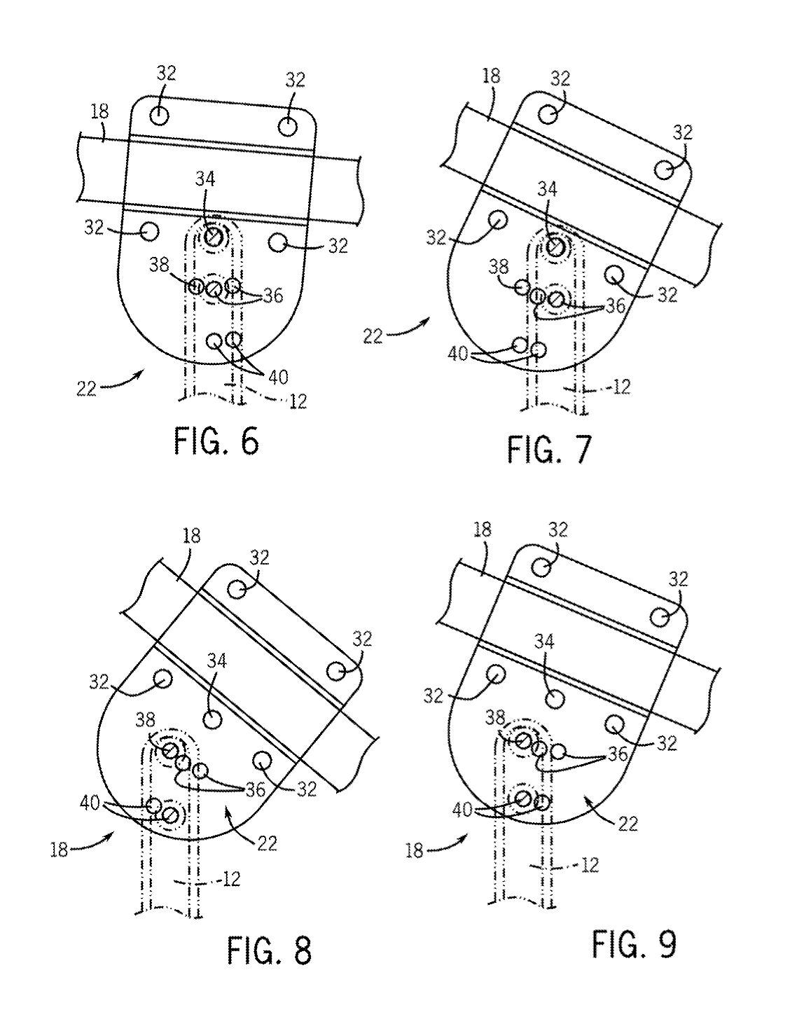

Each one of the legs 44 may include a plurality of retaining fingers 16 on the bottom end. The plurality of retainer fingers 16 may work together to receive and retain a ball 14. The balls 14 may be used as a sliding and gliding surface. The balls 14 may have a diameter of at least 3.5 inches in order to glide and/or slide over rough or sandy surfaces when not rolling. The slot 48 may hold and secure the bracket system 22. The bracket system 22 may pivot inside the slot 48. The pivot movement may permit the user to adjust the position/angle of the bracket system 22 with respect to the shaft 18 (FIGS. 6-9). Fastener devices 24 may be used to secure the bracket system 22 inside the slot 48.

In some embodiments, the base 12 may include a first and second bodies (not shown) coupled together. The first and second bodies (not shown) may be mirror images of each other.

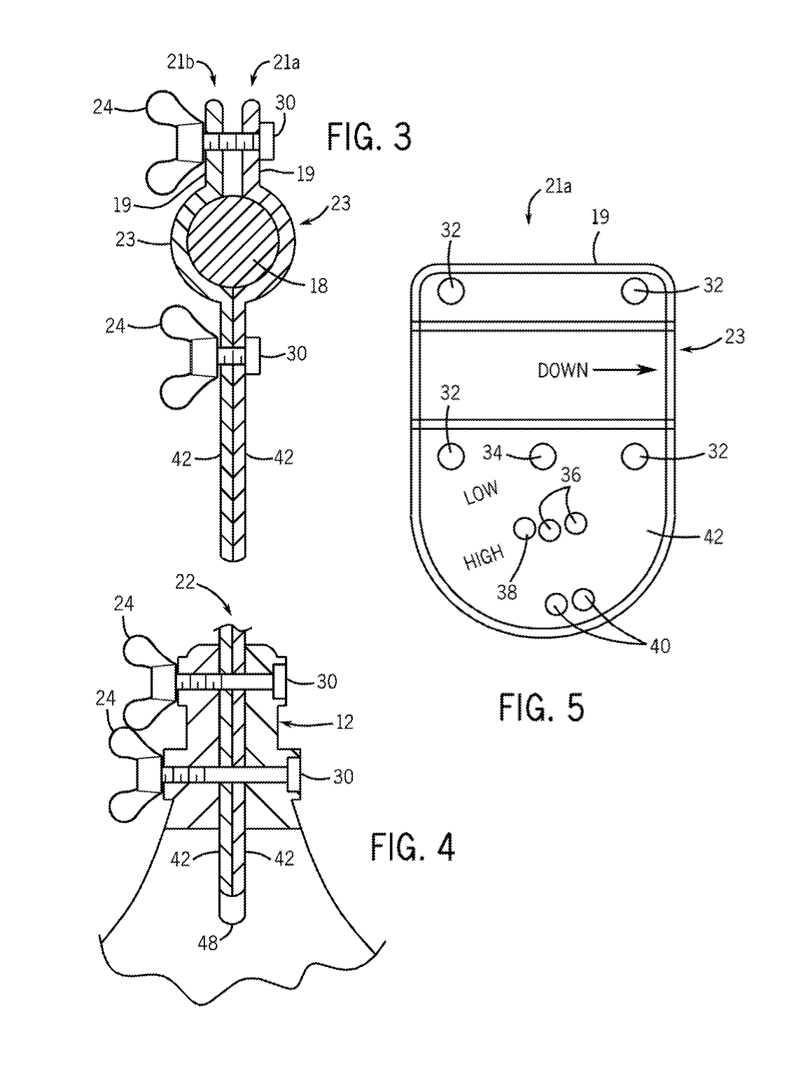

FIG. 3 illustrates that the bracket system 22 may include a first plate 21a and a second plate 21b. The first plate 21a and the second plate 21b may be mirror images of each other. The first plate 21a and the second plate 21 b may be coupled together to hold the shaft 18. The first plate 21a and the second plate 21b may be made of a sturdy material. In some embodiments, the first plate 21a and the second plate 21b may be made of plastic, metal, polymer, fiber reinforced plastic, or composite material. The size of the first plate 21a and the second plate 21b may depend on the size of the shaft 18 of the lawn trimmer 26. The first plate 21a and the second plate 21b may have a geometrical shape. In some embodiments, the shape of the plates 21a, 21b may be square, rectangular, round, or triangular. The plates 21a, 21b may have a ridged texture to provide a good grip of the shaft 18.

A T or wing handle (not shown) may be added to the top of the bracket system 22 for easy adjustment of position or angle of the stabilizer device 10 with respect to the shaft 18.

In some embodiments, the bracket system 22 may be a one piece bracket.

FIG. 5 illustrates that each plate 21a, 21b may include a top section 19, a middle section 23, and a bottom section 42. The top section 19 may be flat and may include a plurality of mounting holes 32 adapted to receive fasteners 24 to couple the first plate 21a and the second plate 21b. The number of mounting holes 32 may depend on the size of the plate 21a, 21b.

The middle section 23 may be adapted to receive and hold the shaft 18 of the lawn trimmer 26. The middle section 23 may be curved to accommodate the shape of the shaft 18. The radius of the curve of the middle section 23 may depend on the size of the shaft 18. The bottom section 42 may be flat and may include a plurality of mounting holes 32 near the middle section 23. A top pivot hole 34 and a bottom pivot hole 38 may be placed on the vertical center line (not shown) of the plate 21a, 21b. The top pivot hole 34 and a bottom pivot hole 38 may allow the base 12 to be secured to the bracket system 22.

Low pivot locking holes 36 and high pivot locking holes 40 may be placed on the bottom section 42 of each plate 21a, 21b. The low pivot locking holes 36 and the high pivot locking holes 40 may allow positioning the bracket system 22 at different angles with respect to the shaft 18.

In some embodiments, the plates include a plurality of low pivot locking holes 36 and a plurality of high pivot locking holes 40. This design may allow the user to lock the plates 21a, 21b on different positions with regards to the shaft 18.

In some embodiments, the plates 21a, 21b may be telescopic in order to adjust the position of the plates 21a, 21b with respect to the shaft 18.

Fastener devices 24, 30 may be used to secure the base 12 to be secured to the bracket system 22. The fastener devices 24, 30 may be a commercially available fastener that may allow the user to quickly connect and disconnect the plates 21a, 21b. In some embodiments, the fastener devices 24, 30, may be screw and nut fasteners or bolt and nut fasteners.

FIG. 4 illustrates that the bottom section 42 of the plates 21a, 21bmay be placed on the slot 48 of the vertical frame 13. Fastener devices 24, 30 may be used to secure the bottom section 42 of the plates 21a, 21b to the vertical frame 13.

The stabilizer device 10 may be a lightweight device. In addition, the stabilizer device 10 may be paint of any color.

The stabilizer device 10 may help support the lawn trimmer as it trims both horizontally and vertically. In addition, the stabilizer device 10 may be height adjustable and may allow the lawn trimmer head to be placed close to plants or other objects to provide stability if the string snags an object. The stabilizer device 10 may be used with leaf blowers, vacuums, metal detectors, cable detectors, wash wands, or commercially available supported devices.

It should be understood, of course, that the foregoing relates to exemplary embodiments of the invention and that modifications may be made without departing from the spirit and scope of the invention as set forth in the following claims.

What is claimed is:

1. A stabilizer device for a lawn trimmer, comprising:
a bracket system adapted to be attached to a shaft of the lawn trimmer;
a base connected to the bracket system;
wherein the base includes a vertical frame having a first leg and a second leg;
wherein each one of the legs includes a plurality of retaining fingers connected to a bottom end; and
wherein the plurality of retainer fingers work together to receive and retain a ball.

2. The stabilizer according to claim 1, wherein the vertical frame includes a slot, wherein the slot holds and secures the bracket system.

3. The stabilizer according to claim 2, wherein the bracket system pivots inside the slot.

4. The stabilizer according to claim 1, further including fastener devices adapted to attach the stabilizer device to the shaft and the base to the bracket system.

5. The stabilizer according to claim 1, wherein the bracket system includes a first plate and a second plate coupled together, wherein each plate includes a top section, a middle section, and a bottom section, wherein the middle section is curved, wherein the middle section is adapted to receive and hold the shaft of the lawn trimmer.

6. The stabilizer according to claim 5, wherein the bottom section and the top section are flat, wherein the bottom section and the top section include a plurality of mounting holes on which fastener devices are positioned to secure the first plate to the second plate.

7. The stabilizer according to claim 5, further comprising a top pivot hole and a bottom pivot hole on the bottom section of each plate, wherein fastener devices are positioned on the top pivot hole and the bottom pivot hole to attach the base to the bracket system.

8. The stabilizer according to claim 5, further comprising at least one low pivot locking hole and at least one high pivot locking hole on the bottom section of each plate, wherein the low pivot locking holes and the high pivot locking holes position the bracket system at different angles with respect to the shaft.

9. The stabilizer according to claim 1, wherein the stabilizer device is a height adjustable stabilizer.
